(19) United States
(12) Patent Application Publication
(10) Pub. No.: US 2026/0271832 A1
(43) Pub. Date: Sep. 17, 2026

(54) SELF-UNLOADING CONTAINER

(71) Applicant: PeK Automotive D.O.O., LOGATEC (SI)

(72) Inventor: Mikhail KOSTKIN, Vrhnika (SI)

(21) Appl. No.: 19/157,354

(22) PCT Filed: Sep. 3, 2023
(86) PCT No.: PCT/IB2023/000059

§ 371 Date: Aug. 16, 2025

(51) Int. Cl. A01D 46/22

(52) U.S. Cl. CPC A01D 46/22

(57) ABSTRACT

The invention relates to agricultural equipment. The container includes a rectangular base with two container half-bodies turnably attached to its inner lateral sides. The base sides have vertical holes housing movable rods, to which an upper crossarm and a lower crossarm are attached. The upper crossarm is equipped with load clamps and a locking mechanism for locking the upper crossarm to the base. The lateral sides of half-bodies adjacent to the base are equipped with stops.

### FIELD OF INVENTION

The invention relates to agricultural equipment, more specifically to containers for collecting fruit and vegetables, which are designed to automatically unload the agricultural products.

### PRIOR ART

Various designs of containers for collecting agricultural products capable of self-unloading are known.

Patent RU1807968, publication date 1993.04.07, ICL B65D88/54, discloses the design of a self-unloading container consisting of two articulated half-bins with lifting lugs, and a horizontal crossarm with a hoist yoke fixed on the hinges of the half-bins. The horizontal crossarm consists of a supporting and unloading beams spaced from each other. The beams are capable of moving along vertical guides, which are rigidly attached to lifting brackets. The unloading beam has hooks axially fixed thereto. The axes of the hooks lie in the same vertical plane, which passes through the axes of the hoist yoke and lifting lugs. Longitudinally to the unloading beam, an axle is installed carrying a rigidly fixed two-arm lever and eccentric cams capable of contacting the hooks. A counterweight is installed at one end of the two-arm lever, and a flexible rod at its other end.

Also known is Italian patent ITBZ960037, publication date 1998 Mar. 2, which describes a self-unloading container. The container has a bottom consisting of two articulated plates, which turn and open the bottom of the container. Each plate is turned by a lever system driven by a vertical rod.

Furthermore, utility model patent CN112830414, publication date 2021 May 25, ICL A01D46/20 describes the design of a container for collecting fruit and vegetables. Its housing contains internal flaps, an actuator and a controller. The container body consists of front, rear and side walls. On the inside, the flaps are turnably hinged to the side walls. The walls are turned by actuators commanded by the controller.

The above design is the closest analog to the case in point.

### DISCLOSURE OF INVENTION

The technical result achieved by the present invention consists of simplifying the design and operation, both in manual and remote modes, of a self-unloading container.

The self-unloading container includes a rectangular base carrying two halves of the container body turnably hinged to the inner sides of said base. The inner sides of the base have vertical holes, which house moveably mounted rods, with an upper and lower crossarms attached to said rods above the upper and under the lower sides of the base, respectively. The upper crossarm is equipped with load clamps and a locking mechanism for locking the upper crossarm to the base. Stops for limiting the turn of the container half-bodies relative to the lower crossarm are mounted on half-body sides adjacent to the base.

Said base is designed in the form of a frame.

Besides, each half-body is hinged to the base to enable its turning.

The rods, being rigidly mounted between the upper and lower crossarms, form a single structure located on each side of the base and are capable of vertical motion through the holes of the base.

The locking mechanism contains a handle capable of unlocking the upper crossarm from the base. Therewith, said locking mechanism additionally contains an electromagnetic actuator, and said handle contains a metal insert.

Each upper crossarm carries load clamps mounted on its edges.

### BRIEF DESCRIPTION OF DRAWINGS

FIG. 1 shows a general view of the self-unloading container for collecting fruit during loading and transportation operations.

FIG. 2 gives a general view of the self-unloading container for collecting fruit during container unloading.

FIG. 3 shows a side view of the container in closed position.

FIG. 4 shows a side view of the container in open position.

FIG. 5 shows the container loaded with fruit or vegetables being moved to an unloading site.

FIG. 6 shows the container loaded with fruit or vegetables inside a storage bin.

FIG. 7 shows the handle with a locking mechanism.

FIG. 8 shows a design of the electromagnetic actuator for remote control of the locking device.

### EMBODIMENTS OF THE INVENTION

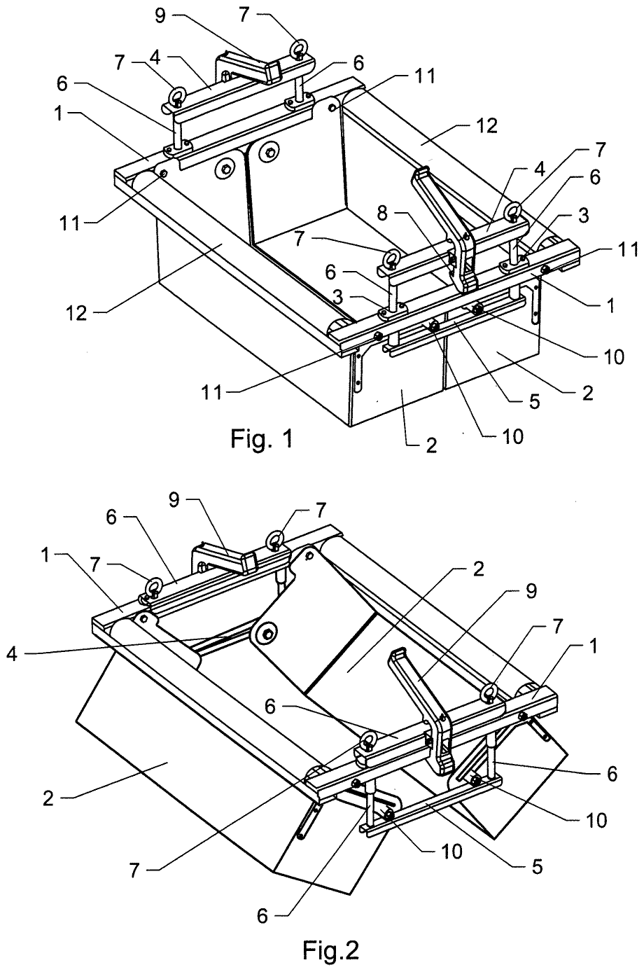

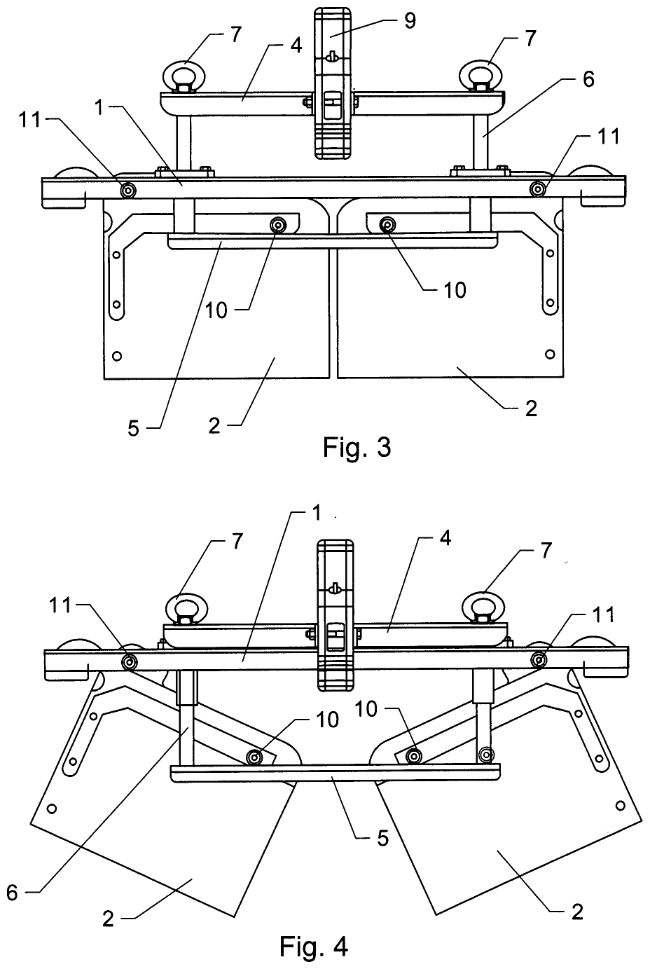

The self-unloading container (FIG. 1-FIG. 6 includes a rectangular base 1, for example, in the form of a frame, with two halves of the container body 2 being turnably hinged (11) to the inner sides of said base 1. The sides of base 1 have vertical holes 3 housing rods 6. The rods 6 have an upper crossarm 4 and a lower crossarm 5 attached to them above the upper and under the lower sides of the base 1, respectively.

Therewith, the rods 6, being rigidly fixed between the upper crossarm 4 and the lower crossarm 5, form a single structure located on each side of the base 1, and are able to move vertically through the holes 3 of the base 1.

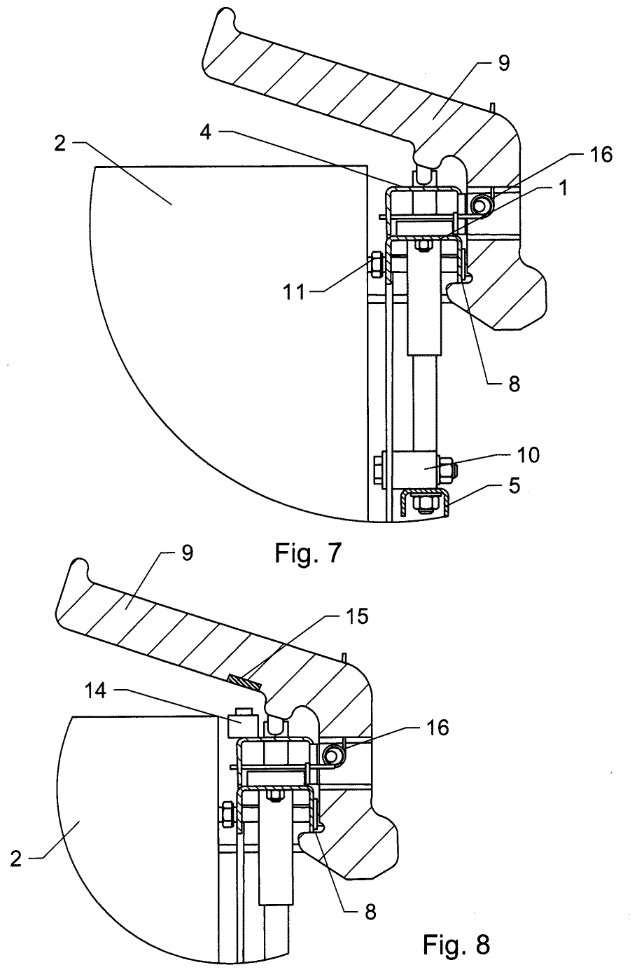

Each upper crossarm 4 carries load clamps 7 mounted on its edges. Besides, each upper crossarm 4 has a handle 9 equipped with a locking mechanism 8 containing a spring 16 for locking the upper crossarm 4 to the base 1 (FIG. 7, FIG. 8).

The sides of half-bodies 2 of the container, which are adjacent to the base 1, are equipped with stops 10, which limit the turn of the half-bodies 2 of the container relative to the lower crossarm 5.

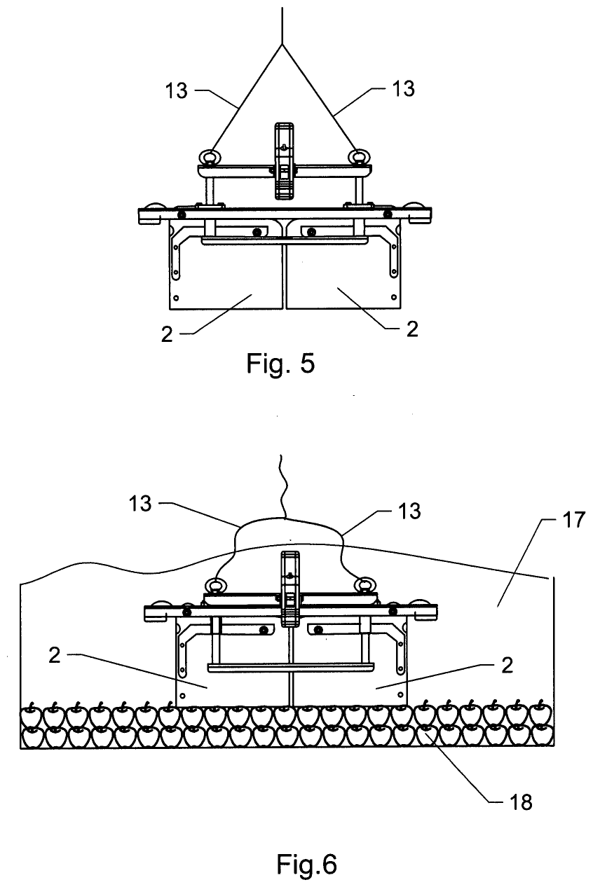

Slings 13, made from ropes or cables and attached to each load clamp, serve for lifting and moving the container, thus forming a container lifting system (FIG. 5, FIG. 6).

The upper longitudinal edges of the base 1 are covered with flexible protective shells 12 to protect fruit or vegetables from damage at loading operation.

The separation of the half-bodies 2 of the container for its self-unloading is triggered by the following conditions: the container is placed on any supporting surface, thus slackening the slings; the locking mechanism 8 turns off, which releases the fastened upper crossarm 4 from the base 1.

The locking mechanism 8 can be actuated manually by pressing the lever 9 to overcome the resistance of spring 16 holding the lever 9 and locking mechanism 8 in a closed position, or remotely, for example, by means of an electromagnetic actuator 14.

To make the remote electromagnetic actuator work, the lever 9 must be made of metal or have a metal insert 15.

Therefore, another specific feature of the proposed self-unloading container design is the availability of both manual and remote control modes.

When loading fruit or vegetables, the self-unloading container can be placed on any supporting surface, or be suspended. If, having reached the unloading site the loaded container must be immediately unloaded, its locking mechanism 8 must be switched, manually or remotely, to the position ensuring that upper crossarm 4 is not locked to the base 1. If the container is supposed to be moved and temporarily placed on some support without unloading, its locking mechanism 8 must be switched to the position which ensures that the upper crossarm 4 stays locked to the base 1.

The container self-unloading operation runs as follows. The loaded container (FIG. 5) is hauled from the loading site. The locking mechanism 8 is switched to the position ensuring that the upper crossarm is not locked to the base 1. The upper crossarm 4, together with the rods 6 and the lower crossarm 5, is held in the upper position only by the tension of the slings 13. When the container is lowered into a bin 17 for storing fruit, apples 18 in the case at hand (FIG. 5), the slings 13 slack and the half-bodies 2 open as soon as the container is lifted (FIG. 2, FIG. 4) and the apples 18 flow into the bin 17. The half-bodies 2 separate because the rods 6, which are rigidly fixed between the upper crossarms 4 and the lower crossarms 5 thus forming a single structure, move vertically downwards in the holes 3 of the base 1 allowing the clamps 10 to abut against the lower crossarm 5.

### INDUSTRIAL APPLICABILITY

This design provides simplicity and versatility of device application, and can be used for various types of activities aside from collection and transportation of agricultural products.

1. A self-unloading container, including a rectangular base with two container half-bodies turnably attached to the inner sides of said base, wherein the sides of said base have vertical holes housing movable rods, the latter being attached an upper crossarm and a lower crossarm above the upper and under the lower sides of the base, respectively; said upper crossarm has load clamps and a locking mechanism capable of fastening the upper crossarm to the base; meanwhile, the lateral sides of the half-bodies adjacent to the base have stops to limit the turn of container half-bodies relative to the bottom crossarm.

2. A container as per claim 1, wherein the base is made in the form of a frame.

3. A container as per claim 1, wherein each container half-body is turnably hinged to the base.

4. A container as per claim 1, wherein the rods, rigidly set between the upper and lower crossarms, form a single structure located on each side of the base and capable of vertically moving through the holes of the base.

5. A container as per claim 1, wherein the locking mechanism includes a handle capable of releasing the upper crossarm from the base.

6. A container as per claim 5, wherein the locking mechanism is additionally equipped with an electromagnetic actuator, while the handle contains a metal insert.

7. A container as per claim 1, wherein load clamps are attached to the edges of each upper crossarm.
